(19) United States
(12) Patent Application Publication
(10) Pub. No.: US 2013/0169861 A1
(43) Pub. Date: Jul. 4, 2013

(54) IMAGE PICKUP APPARATUS AND POWER SUPPLY METHOD

(71) Applicant: Sony Corporation, Tokyo (JP)

(72) Inventor: Tetsuma YOSHINO, Tokyo (JP)

(73) Assignee: Sony Corporation, Tokyo (JP)

(21) Appl. No.: 13/673,008

(22) Filed: Nov. 9, 2012

(30) Foreign Application Priority Data
Dec. 29, 2011 (JP) 2011-290377

(51) Int. Cl. H04N 5/232; H02J 4/00

(52) U.S. Cl. CPC H04N 5/23241; H02J 4/00
USPC 348/372; 307/38

(57) ABSTRACT

An image pickup apparatus includes an image pickup control portion which includes an image pickup portion and a processing portion performing a process of image picking-up; a position information acquiring portion which acquires position information; a time information acquiring portion which acquires time information; and a power management portion which controls supply of power to the portions, the power management portion and the time information acquiring portion are continuously supplied with power, when the time information corresponds to a predicted use time, the position information acquiring portion is supplied with power, and when the position information is separated from position information of a predetermined place by a predetermined distance or more, a memory for program execution is supplied with power.

### BACKGROUND

The present disclosure relates to, for example, an image pickup apparatus which can be activated at high speed and a power supply method.

There are various proposals for shortening a time for activating an image pickup apparatus. For example, Japanese Unexamined Patent Application Publication No. 2007-133621 describes a technique of setting the state of a digital still camera to a hot boot holding state in accordance with information obtained with reference to the usage history of a user.

### SUMMARY

The time for which a user actually uses a digital still camera does not necessarily match the information obtained from the usage history.

It is desirable to provide an image pickup apparatus which can be activated at high speed when there is a high possibility of actually using the image pickup apparatus such as a digital still camera, and a power supply method.

According to an embodiment of the present disclosure, there is provided an image pickup apparatus including an image pickup control portion which includes an image pickup portion and a processing portion performing a process of image picking-up; a position information acquiring portion which acquires position information; a time information acquiring portion which acquires time information; and a power management portion which controls supply of power to the portions, in which the power management portion and the time information acquiring portion are continuously supplied with power, when the time information corresponds to a predicted use time, the position information acquiring portion is supplied with power, and when the position information is separated from position information of a predetermined place by a predetermined distance or more, a memory for program execution is supplied with power.

According to another embodiment of the present disclosure, there is provided an image pickup apparatus which can transit to a state in which at least a continuously operating portion and a memory for program execution are supplied with power, and transits to the state when time information corresponds to a predicted use time and position information is separated from position information of a predetermined place by a predetermined distance or more.

According to still another embodiment of the present disclosure, there is provided an image pickup apparatus including an image pickup control portion which includes an image pickup portion and a processing portion performing a process of image picking-up; an oscillation information acquiring portion which acquires oscillation information; a time information acquiring portion which acquires time information; and a power management portion which controls supply of power to the portions, in which the power management portion and the time information acquiring portion are continuously supplied with power, when the time information corresponds to a predicted use time, the oscillation information acquiring portion is supplied with power, and when the oscillation information is a predetermined value or more, a memory for program execution is supplied with power.

According to still another embodiment of the present disclosure, there is provided an image pickup apparatus which can transit to a state in which at least a continuously operating portion and a memory for program execution are supplied with power, and transits to the state when time information corresponds to a predicted use time and oscillation information is a predetermined value or more.

According to still another embodiment of the present disclosure, there is provided a power supply method in which a power management portion and a time information acquiring portion are continuously supplied with power, when time information corresponds to a predicted use time, a position information acquiring portion is supplied with power, and when position information is separated from position information of a predetermined place by a predetermined distance or more, a memory for program execution is supplied with power.

According to still another embodiment of the present disclosure, there is provided a power supply method in which a power management portion and a time information acquiring portion are continuously supplied with power, when time information corresponds to a predicted use time, an oscillation information acquiring portion is supplied with power, and when oscillation information is a predetermined value or more, a memory for program execution is supplied with power.

According to at least one embodiment of the present disclosure, it is possible to activate an image pickup apparatus at high speed when there is a high possibility of actually using the image pickup apparatus.

### BRIEF DESCRIPTION OF THE DRAWINGS

FIG. 1 is a block diagram showing an example of the configuration of an image pickup apparatus which is generally used;

FIG. 2 is a block diagram showing an example of the configuration of an image pickup apparatus according to a first embodiment;

FIG. 3 is a schematic diagram showing an example of the supply of power in a power-on state;

FIG. 4 is a schematic diagram showing an example of the supply of power in a hot-off state;

FIG. 5 is a schematic diagram showing an example of the supply of power in a cold-off state;

FIG. 6 is a schematic diagram showing an example of the supply of power in a hot-off transition determination state;

FIG. 7 is a diagram for illustrating an example of the transition of a state of the image pickup apparatus, and the like; and

FIG. 8 is a block diagram showing an example of the configuration of an image pickup apparatus according to a second embodiment.

### DETAILED DESCRIPTION OF EMBODIMENTS

Hereinafter, embodiments of the present disclosure will be described with reference to the drawings. The description will be performed in the following order.

1. First Embodiment

2. Second Embodiment

3. Modification Examples

Embodiments and modification examples which will be described below are preferred specific examples of the present disclosure, and the content of the present disclosure is not limited to the embodiments and modification examples.

### 1. First Embodiment

Configuration of Generally Used Image Pickup Apparatus

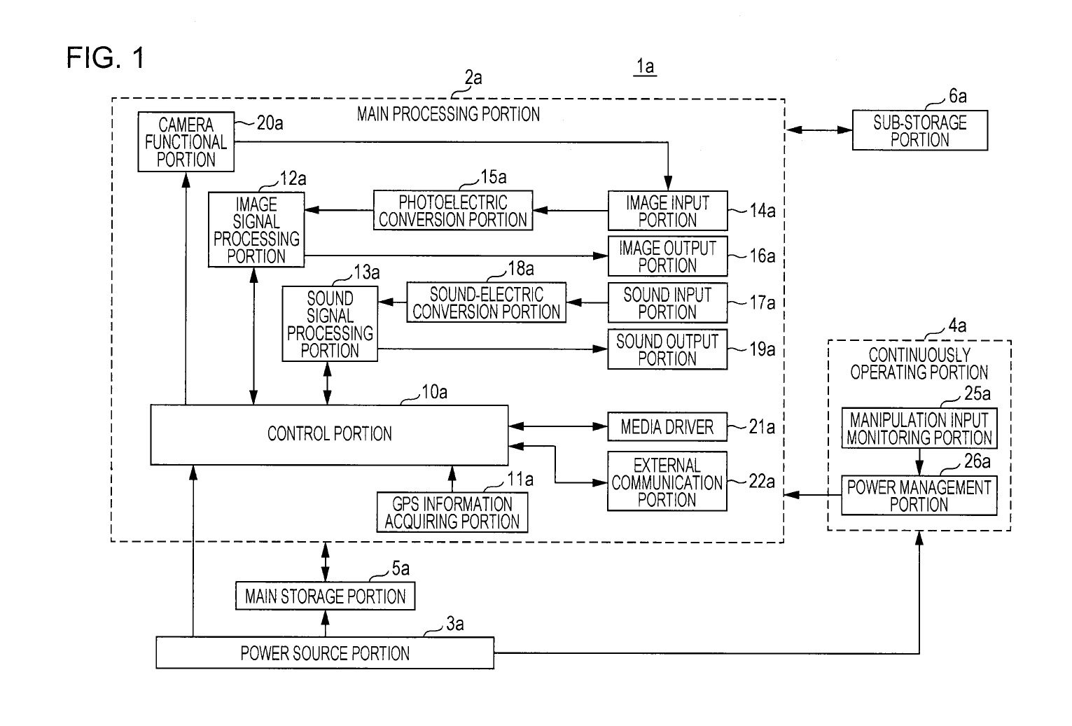

First, an example of the configuration of an image pickup apparatus which is generally used will be described in order to facilitate understanding of the present disclosure. FIG. 1 shows an example of the configuration of an image pickup apparatus which is generally used. An image pickup apparatus 1a illustrated in FIG. 1 has a function of picking up at least one of a moving image and a still image.

The image pickup apparatus 1a includes a main processing portion 2a, a power source portion 3a, a continuously operating portion 4a, a main storage portion 5a, and a sub-storage portion 6a. In the image pickup apparatus 1a, the main processing portion 2a mainly executes a process. The power source portion 3a is, for example, a secondary battery which is detachably mounted on the image pickup apparatus 1a. The power source portion 3a is charged in a state mounted on the image pickup apparatus 1a. The power source portion 3a detached from the image pickup apparatus 1a may be charged by a dedicated charger.

When the power source portion 3a is mounted on the image pickup apparatus 1a, the power source portion 3a continuously supplies power to the continuously operating portion 4a. Therefore, even when the image pickup apparatus 1a is turned off, the continuously operating portion 4a can be operated. The main storage portion 5a and the sub-storage portion 6a are connected to the main processing portion 2a. The main storage portion 5a is, for example, volatile memory. The sub-storage portion 6a is formed of, for example, a nonvolatile memory. The sub-storage portion 6a is supplied with power via the main processing portion 2a. The “main” and “sub-” are given for convenience of description and do not have particular meanings.

The main processing portion 2a has a control portion 10a. The control portion 10a controls the portions of the image pickup apparatus 1a. Furthermore, the main processing portion 2a includes a Global Positioning System (GPS) information acquiring portion 11a, an image signal processing portion 12a, a sound signal processing portion 13a, an image input portion 14a, a photoelectric conversion portion 15a, an image output portion 16a, a sound input portion 17a, a sound-electric conversion portion 18a, a sound output portion 19a, a camera functional portion 20a, a media driver 21a, and an external communication portion 22a. The portions of the main processing portion 2a are supplied with power via the control portion 10a.

The continuously operating portion 4a includes a manipulation input monitoring portion 25a and a power management portion 26a. The image pickup apparatus 1a is provided with a power switch to turn on/off the image pickup apparatus 1a. For example, the manipulation input monitoring portion 25a monitors the manipulation of the power switch and generates a trigger signal corresponding to the manipulation of the power switch. The generated manipulation signal is supplied to the power management portion 26a. The power management portion 26a controls the supply of power to the portions of the image pickup apparatus 1a.

Operation of Generally Used Image Pickup Apparatus

Next, an example of the operation of the image pickup apparatus 1a when the power switch is turned on or off will be described on the assumption that the power source portion 3a is mounted on the image pickup apparatus 1a. When the power switch is turned off, only the continuously operating portion 4a is supplied with power. When a power-on manipulation is performed to turn on the power switch, the manipulation input monitoring portion 25a detects the manipulation. The manipulation input monitoring portion 25a supplies a trigger signal corresponding to the power-on manipulation to the power management portion 26a. When receiving the trigger signal corresponding to the power-on manipulation, the power management portion 26a supplies power to the main processing portion 2a and the main storage portion 5a.

Next, an activation process (boot process) is executed. For the activation process, for example, a program (hereinafter, appropriately referred to as the activation program) necessary for the activation is loaded to the main storage portion 5a. The control portion 10a executes the content of the activation program after waiting for loading of the activation program to the main storage portion 5a. After the activation process, a user can use the image pickup apparatus 1a. Since the activation program is loaded after the power-on manipulation and the activation process is then performed, there is a problem in that it takes a long time to activate the image pickup apparatus.

Example of Configuration of Image Pickup Apparatus According to First Embodiment

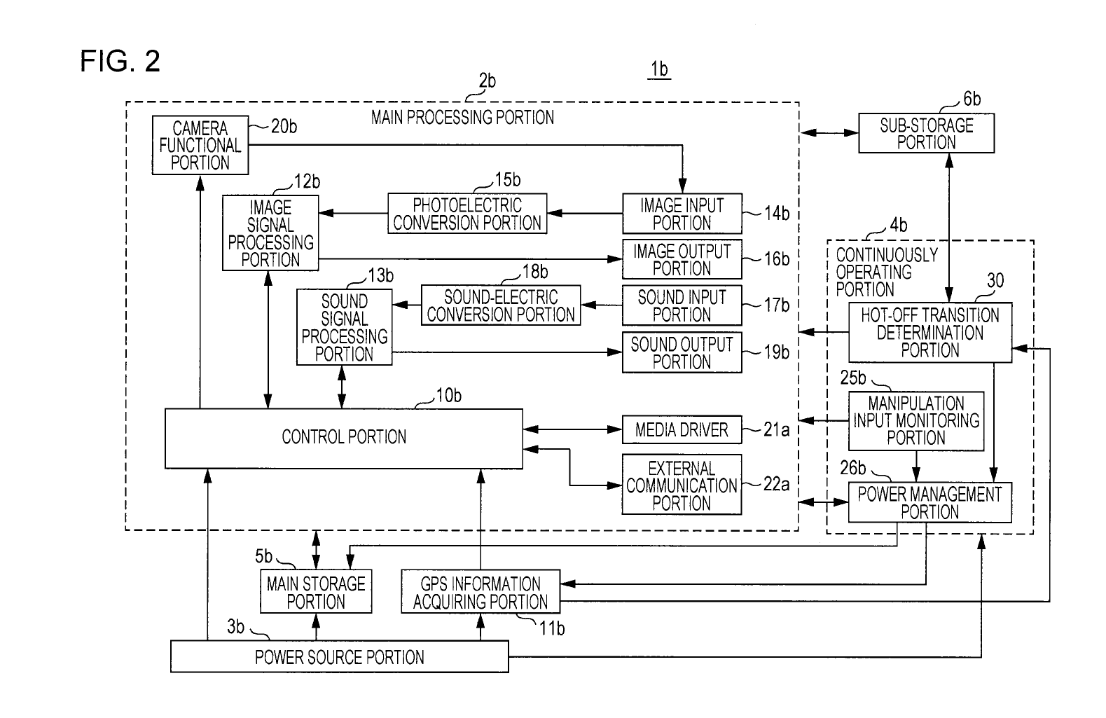

FIG. 2 shows an example of the configuration of an image pickup apparatus according to a first embodiment. An image pickup apparatus 1b illustrated in FIG. 2 has a function of picking up at least one of a moving image and a still image. In the following description, the image includes at least one of a moving image and a still image unless otherwise mentioned. The image pickup apparatus 1b includes, for example, a main processing portion 2b, a power source portion 3b, a continuously operating portion 4b, a main storage portion 5b, a sub-storage portion 6b, and a GPS information acquiring portion 11b. Hereinafter, the configurations of the portions will be described in detail.

Main Processing Portion

The main processing portion 2b as an example of an image pickup control portion executes a process of reproducing an image which has been picked up or subjected to an image pickup process. The main processing portion 2b includes a control portion 10b, an image signal processing portion 12b, a sound signal processing portion 13b, an image input portion 14b, a photoelectric conversion portion 15b, an image output portion 16b, a sound input portion 17b, a sound-electric conversion portion 18b, a sound output portion 19b, a camera functional portion 20b, a media driver 21b, and an external communication portion 22b.

For example, the control portion 10b controls the portions of the main processing portion 2b, writes or reads out data on or from the main storage portion 5b and the sub-storage portion 6b, and executes a process corresponding to a command supplied from the continuously operating portion 4b. Furthermore, the control portion 10b calculates a predicted use time using meta-information accompanying contents data such as images and sounds.

The image input portion 14b includes, for example, an optical system such as a lens for picking up an image of a subject. The photoelectric conversion portion 15b is formed of an image pickup device such as a Charge Coupled Device (CCD) or a Complementary Metal Oxide Semiconductor (CMOS), and converts a formed subject image into an analog image signal on the basis of a timing signal supplied from the control portion 10b.

The image input portion 14b includes driving systems such as a mechanism which drives and moves the optical system such as a lens and the image pickup device to a predetermined position, a mechanism which adjusts an aperture, a mechanism which adjusts a focus, a mechanism which adjusts a zoom, and a mechanism which corrects shaking. These driving systems are controlled by the camera functional portion 20b. The camera functional portion 20b controls the image input portion 14b in accordance with a control signal from the control portion 10b. The function of the camera functional portion 20b may be incorporated into the control portion 10b.

The photoelectric conversion portion 15b supplies the analog image signal to the image signal processing portion 12b. The image signal processing portion 12b is constituted of an analog signal processing portion, an A/D (Analog to Digital) conversion portion, a digital signal processing portion, and the like. The analog signal processing portion subjects the analog image signal supplied from the photoelectric conversion portion 15b to a Correlated Double Sampling (CDS) process to obtain a favorable S/N (Signal to Noise) ratio, and subjects the analog image signal to an Automatic Gain Control (AGC) process to control the gains. The A/D conversion portion converts the analog image signal subjected to the analog signal process into a digital image signal. The digital image signal is supplied to the digital signal processing portion.

The digital signal processing portion subjects the digital image signal to a demosaic process and a camera signal process such as Automatic Focus (AF), Automatic Exposure (AE), and Automatic White Balance (AWB). Furthermore, in order to store the digital image signal on a memory, the digital signal processing portion encodes the digital image signal into a form corresponding to the memory and forms digital image data. When an image is reproduced, the image signal processing portion 12b decodes image data read out from the memory. Regarding a predetermined format, for example, there is an Advanced Video Codec High Definition (AVHCD) (registered trade mark) format for the case of a moving image, and there is a Joint Photographic Experts Group (JPEG) format for the case of a still image.

The memory (omitted in the drawing) having the digital image data stored thereon is an embedded memory such as a hard disk which is embedded in the image pickup apparatus 1b. It may be an external memory such as a Universal Serial Bus (USB) memory or a flash memory which is detachably mounted on the image pickup apparatus 1b. The writing or reading-out of data on or from the embedded memory and the external memory are executed by the media driver 21b. For example, digital image data is output from the image signal processing portion 12b. The digital image data is supplied to the media driver 21b by control of the control portion 10b. The media driver 21b writes the digital image data on the external memory.

When digital image data is stored on the embedded memory or the external memory, meta-information (accompanying information) is stored in association with the digital image data. The meta-information includes time information at which the digital image data is picked up, image pickup position, setting information of the image pickup apparatus 1b at the time of picking up the image, and the like. The time information is, for example, information formed of year, date, hour, and minute.

The image output portion 16b includes a display panel such as a liquid crystal panel or an organic Electroluminescence (EL) panel and a display driver which drives the display panel. The image output portion 16b displays a through image at the time when the image of a subject is picked up, or reproduces and displays an image stored on the embedded memory or the external memory. For example, the media driver 21b reads out digital image data stored on the external memory. The readout digital image data is supplied to the image signal processing portion 12b by control of the control portion 10b. The digital image signal decoded by the image signal processing portion 12b is supplied to the image output portion 16b. The display driver of the image output portion 16b is operated and the image is displayed on the image output portion 16b.

Other information may be displayed on the image output portion 16b. For example, a menu screen for manipulating the image pickup apparatus 1b, or information with regard to the remaining capacity of the power source portion 3b may be displayed. The image output portion 16b may be configured as a touch panel.

The sound input portion 17b is formed of one or more microphones, and collects the sound around the image pickup apparatus 1b. For example, the sound input portion 17b collects voices and sounds of nature. The sound-electric conversion portion 18b converts the sound collected by the sound input portion 17b into an analog sound signal as an electric signal. The analog sound signal is supplied to the sound signal processing portion 13b.

The sound signal processing portion 13b subjects the supplied analog sound signal to a predetermined process such as a noise process and an A/D conversion process to form a digital sound signal. In addition, the sound signal processing portion 13b encodes the digital sound signal into a form corresponding to the embedded memory or the external memory and forms digital sound data. The digital sound data is, for example, transferred to the media driver 21b by control of the control portion 10b and written on the external memory by the media driver 21b. The digital sound data is, for example, stored on the embedded memory or the external memory in association with predetermined digital image data.

The sound output portion 19b is a speaker device which outputs a sound. For example, the media driver 21b reads out digital sound data stored on the external memory. The readout digital sound data is supplied to the sound signal processing portion 13b by control of the control portion 10b. The sound signal processing portion 13b decodes the digital sound data, and thus a digital sound signal is formed.

The digital sound signal is converted into an analog sound signal. The analog sound signal is amplified, and the amplified analog sound signal is reproduced from the sound output portion 19b. For example, the sound is reproduced with a predetermined moving image. The sound reproduced from the sound output portion 19b may be music data such as Background Music (BGM) stored on the embedded memory or the external memory, other than the sound collected by the sound input portion 17b.

The external communication portion 22b is an interface which performs communication with an external device using the internet, wireless Local Area Network (LAN), wired cable or the like. The external device is, for example, a server or a personal computer connected to the network. Data transmission and reception are performed between the image pickup apparatus 1b and the external device via the external communication portion 22b.

Although omitted in the drawing, the main processing portion 2b has a program memory on which an activation program necessary for the activation process is stored. The program memory may be provided independently from the main processing portion 2b. The program memory is constituted of, for example, a mask Read Only Memory (ROM).

Power Source Portion

The power source portion 3b is, for example, a rechargeable secondary battery. Examples of the secondary battery include a lithium ion secondary battery and a lithium polymer secondary battery. The power source portion 3b is detachably mounted on the image pickup apparatus 1b. The power source portion 3b may be embedded in the image pickup apparatus 1b. The power source portion 3b is charged by being mounted on a dedicated charger in a state detached from the image pickup apparatus 1b. The power source portion 3b may be charged using, for example, a commercial power source in a state in which the power source portion 3b is mounted on the image pickup apparatus 1b.

The power source portion 3b supplies power to the portions of the image pickup apparatus 1b in accordance with the control by a power management portion 26b to be described later. For example, power is supplied to the main processing portion 2b, the continuously operating portion 4b, the main storage portion 5b, and the GPS information acquiring portion 11b from the power source portion 3b. The portions of the main processing portion 2b and the sub-storage portion 6b are supplied with power via the control portion 10b. The supply of power includes a meaning that, for example, the voltage of the power source portion is converted into a voltage corresponding to the supply destination of the power and the converted voltage is supplied to a predetermined supply destination.

Main Storage Portion and Sub-Storage Portion

The main storage portion 5b is an example of a memory for program execution, and is formed of, for example, a volatile Random Access Memory (RAM). The main storage portion 5b is used as, for example, a region in which the main processing portion 2b is held in an initialized state, and as a work area for executing a program by the main processing portion 2b. When the image pickup apparatus 1b transits to a hot-off state to be described later, the activation program stored on the program memory is loaded to the main storage portion 5b.

The sub-storage portion 6b is formed of, for example, a nonvolatile Random Access Memory (RAM). Even when the supply of power from the power source portion 3b is stopped, the sub-storage portion 6b holds the stored contents. The sub-storage portion 6b stores data (hereinafter, appropriately referred to as the predicted use time data) which shows a predicted use time calculated by the control portion 10b. Furthermore, the sub-storage portion 6b stores position information of a predetermined place. The predetermined place is, for example, a user's base such as a home or office of a user, or a broadcasting station. The position information of the predetermined place is, for example, registered in advance by the user.

The sub-storage portion 6b may be used for data backup. For example, the digital image data of an image obtained by image picking-up is stored on the sub-storage portion 6b. The digital image data is allowed to be stored on the embedded memory or the external memory and stored on the sub-storage portion 6b. Accordingly, even when image picking-up is interrupted due to a reduction in the remaining capacity of the power source portion 3b, images can be restored using the digital image data which has been stored on the sub-storage portion 6b by then.

In the main storage portion 5b and the sub-storage portion 6b, the “main” and “sub-” are given for convenience of description and do not have particular meanings.

Continuously Operating Portion

The continuously operating portion 4b is continuously supplied with power from the power source portion 3b. A power source portion or a power storage element different from the power source portion 3b may be provided to continuously supply power to the continuously operating portion 4b. Since the continuously operating portion 4b is continuously supplied with power, the continuously operating portion 4b is operated even when a power switch of the image pickup apparatus 1b is turned off.

The continuously operating portion 4b includes a manipulation input monitoring portion 25b, a power management portion 26b, and a hot-off transition determination portion 30. The manipulation input monitoring portion 25b monitors input performed on the power switch or button provided in the image pickup apparatus 1b and on the manipulation portion such as a zoom key. The manipulation input monitoring portion 25b generates a manipulation signal corresponding to the manipulation, and supplies the generated manipulation signal to the main processing portion 2b. The control portion 10b of the main processing portion 2b executes a process corresponding to the manipulation signal. Furthermore, the manipulation input monitoring portion 25b generates a trigger signal corresponding to the turn-on/off manipulation of the power switch. The generated trigger signal is supplied to the power management portion 26b.

The power management portion 26b controls the supply of power to the portions from the power source portion 3b. For example, a switch is respectively provided between the power source portion 3b and supply destinations to which power is supplied. The power management portion 3b controls turning on/off of the switch, and thus the supply of power to the portions is controlled. The power management portion 26b controls the supply of power in accordance with a trigger signal which is supplied from each of the control portion 10b, the manipulation input monitoring portion 25b, and the hot-off transition determination portion 30.

The hot-off transition determination portion 30 determines whether or not the state transits to a hot-off state from a cold-off state. The hot-off transition determination portion 30 has, for example, a Real Time Clock (RTC), and can acquire time information. The time information measured by the RTC may be supplied to the manipulation input monitoring portion 25b or the power management portion 26b.

The hot-off transition determination portion 30 determines whether or not the state transits to a hot-off state with reference to, for example, the use time prediction data stored on the sub-storage portion 6b and the position information supplied from the GPS information acquiring portion lib. When it is determined that the state transits to the hot-off state, the hot-off transition determination portion 30 outputs a trigger signal to the power management portion 26b. The transition of the state of the image pickup apparatus 1b will be described later in detail.

GPS Information Acquiring Portion

The GPS information acquiring portion 11b as an example of a position information acquiring portion has a GPS receiver to acquire position information at which the image pickup apparatus 1b is present. The GPS information acquiring portion 11b is provided independently from the main processing portion 2b so that the supply of power to the GPS information acquiring portion 11b can be independently controlled. When supplied with power, the GPS information acquiring portion 11b measures position information of the image pickup apparatus 1b, and supplies the measured position information to the hot-off transition determination portion 30.

Example of Image Pickup Apparatus Transition

Next, an example of the transition of the image pickup apparatus 1b will be described. The image pickup apparatus 1b can transit to, for example, four states. As the four states, a power-on state, a hot-off state, a cold-off state, and a hot-off transition determination state are exemplified. In any state, the power source portion 3b is mounted on the image pickup apparatus 1b. The power-on state is a state in which, for example, the power switch is turned on and the image pickup apparatus 1b can be used by a user. In the power-on state, images are picked up or reproduced using the image pickup apparatus 1b.

The hot-off state is a state in which, for example, although the power switch is turned off, the activation program is loaded to the main storage portion 5b and the high-speed activation is possible. The cold-off state is a state in which, for example, the power switch is turned off. In the hot-off state and the cold-off state, there is no particular change in the appearance of the image pickup apparatus 1b. Therefore, a user doesn't recognize whether the image pickup apparatus 1b is in the hot-off state or in the cold-off state.

The hot-off transition determination state is a state in which, for example, it is determined whether or not the state transits to a hot-off state from a cold-off state. The appearance of the image pickup apparatus 1b in the hot-off transition determination state is not different from the appearances of the image pickup apparatus 1b in the hot-off state and in the cold-off state. Therefore, a user doesn't recognize that the image pickup apparatus 1b is in the hot-off transition determination state.

Supply of Power in Image Pickup Apparatus

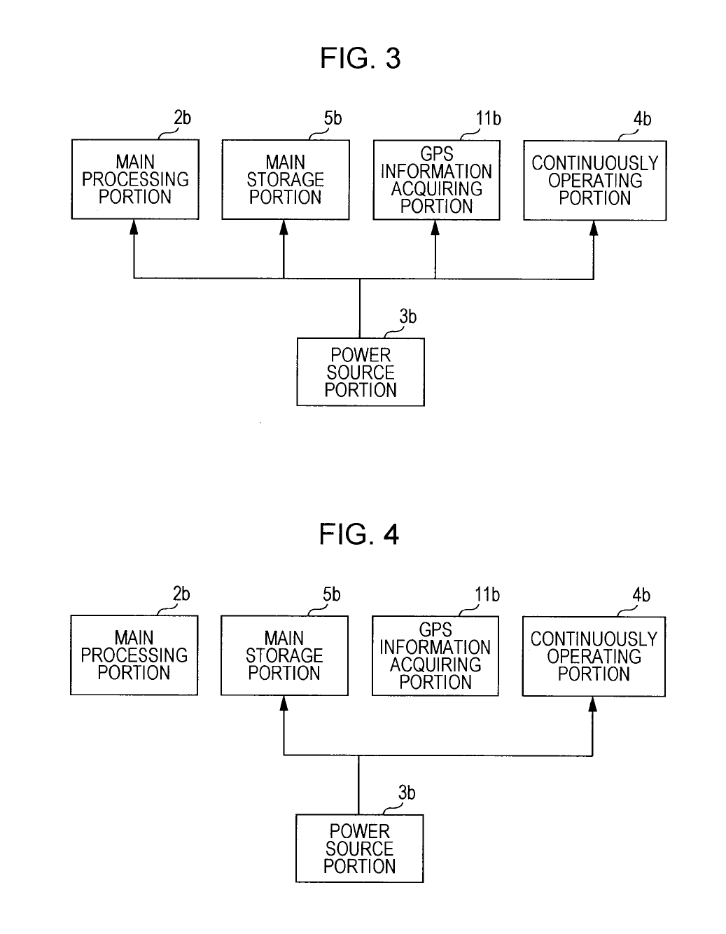

FIG. 3 shows an example of the supply of power in a power-on state. In the power-on state, power is supplied to the portions of the image pickup apparatus 1b from the power source portion 3b. That is, power is supplied to the main processing portion 2b, the main storage portion 5b, the GPS information acquiring portion 11b, and the continuously operating portion 4b from the power source portion 3b. Although omitted in the drawing, the sub-storage portion 6a is supplied with power via the main processing portion 2b. In the power-on state, a user uses the image pickup apparatus 1b. For example, the user picks up an image of a subject, or reproduces an image.

FIG. 4 shows an example of the supply of power in a hot-off state. In the hot-off state, power is supplied to the main storage portion 5b and the continuously operating portion 4b from the power source portion 3b. Since the main storage portion 5b is supplied with power, the activation program is loaded to the main storage portion 5b. Since the activation program is loaded in advance, the activation process can be rapidly performed and the image pickup apparatus 1b can be activated at high speed. In the hot-off state, no power is supplied to the main processing portion 2b and the GPS information acquiring portion 11b.

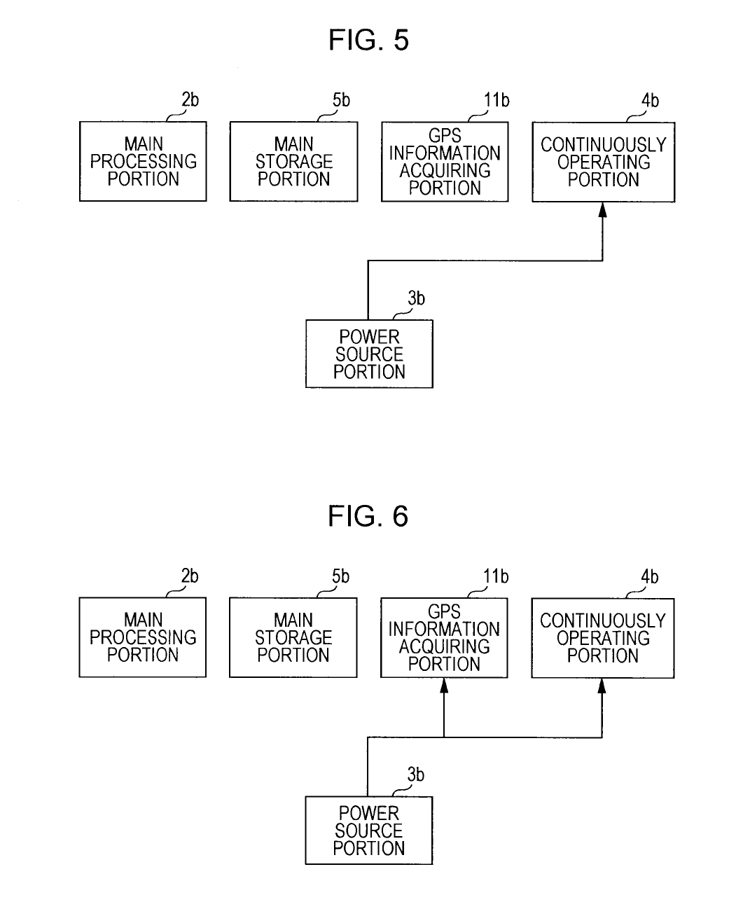

FIG. 5 shows an example of the supply of power in a cold-off state. In the cold-off state, power is supplied to the continuously operating portion 4b from the power source portion 3b. Even when the power switch is turned off, the continuously operating portion 4b is operated, and thus the manipulation of the manipulation portion of the image pickup apparatus 1b can be monitored. In the cold-off state, no power is supplied to the main processing portion 2b, the main storage portion 5b, and the GPS information acquiring portion 11b.

FIG. 6 shows an example of the supply of power in a hot-off transition determination state. In the hot-off transition determination state, power is supplied to the GPS information acquiring portion 11b and the continuously operating portion 4b. In the hot-off transition determination state, no power is supplied to the main processing portion 2b and the main storage portion 5b. Since power can be supplied independently from the GPS information acquiring portion 11b, it is not necessary to supply power to the main processing portion 2b, and thus power consumption can be reduced. Furthermore, it is possible to acquire position information of the image pickup apparatus 1b without activating the main processing portion 2b.

When the image pickup apparatus 1b transits to a hot-off state, the main processing portion 2b is supplied with power. Since power is supplied, the main processing portion 2b moves upward. The state in which the main processing portion 2b moves upward (various pieces of setting information of the image pickup apparatus 1b) is stored on the main storage portion 5b. For example, the activation program is loaded to the main storage portion 5b. In addition, the supply of power to the main processing portion 2b is stopped and the image pickup apparatus 1b transits to the hot-off state.

Calculation of Predicted Use Time

The image pickup apparatus 1b has a function of calculating a predicted use time. The predicted use time is a time period during which there is a high possibility of using the image pickup apparatus 1b by a user. The predicted use time is defined with, for example, day of the week and time. The predicted use time is calculated by, for example, the control portion 10b.

The predicted use time is calculated with reference to, for example, time information in the meta-information of an image. The image may be an image stored in any of the embedded memory and the external memory. However, the image is an image picked up by the image pickup apparatus 1b. Hereinafter, an example of a method of calculating the predicted use time will be described.

First, a day of the week on which the image pickup apparatus 1b is frequently used is calculated. When there are N (for example, 100) images, the numbers of the images are sorted for each day of the week with reference to meta-information. At this time, when a plurality of images are present on the same day of the week, the number of images is set to 1 and sorted to the corresponding day of the week. For example, even when five images are picked up on Saturday, December 1, one is added to the number of images on Saturday. The images are sorted for each day of the week, and the days of the week are sequenced in descending order of the number of images. For example, “Saturday, Sunday, Friday, Thursday, Tuesday, Wednesday, and Monday” is obtained as a day order of descending number of images.

Next, a time period during which the image pickup apparatus 1b is frequently used is calculated. 24 hours are separated for each hour and the numbers of images are sorted for each time period. When a plurality of picked-up images are present during the same time period at the same date, the number of images is counted as one as in the case of the process of determining the day of the week. In addition, the time periods are sequenced in descending order of the number of images. For example, “10:00 to 11:00, 14:00 to 15:00, 16:00 to 17:00” is obtained as a time period order of descending number of images. The time period during which the image pickup apparatus 1b is frequently used may be calculated initially. The day of the week on which and the time period during which the image pickup apparatus 1b is frequently used may be calculated through parallel processing.

Using the day of the week and the time period obtained as described above, the predicted use time is set. For example, “10:00 to 11:00 on Saturday” as high levels of the day of the week and the time period is set as the predicted use time. A plurality of predicted use times may be set. For example, a threshold may be set, and days of the week and time periods having the number of images exceeding the threshold may be set as predicted use times. Predicted use time data showing the predicted use time is stored on, for example, the sub-storage portion 6b. The predicted use time may be set by a user.

Transition of State of Image Pickup Apparatus according to First Embodiment

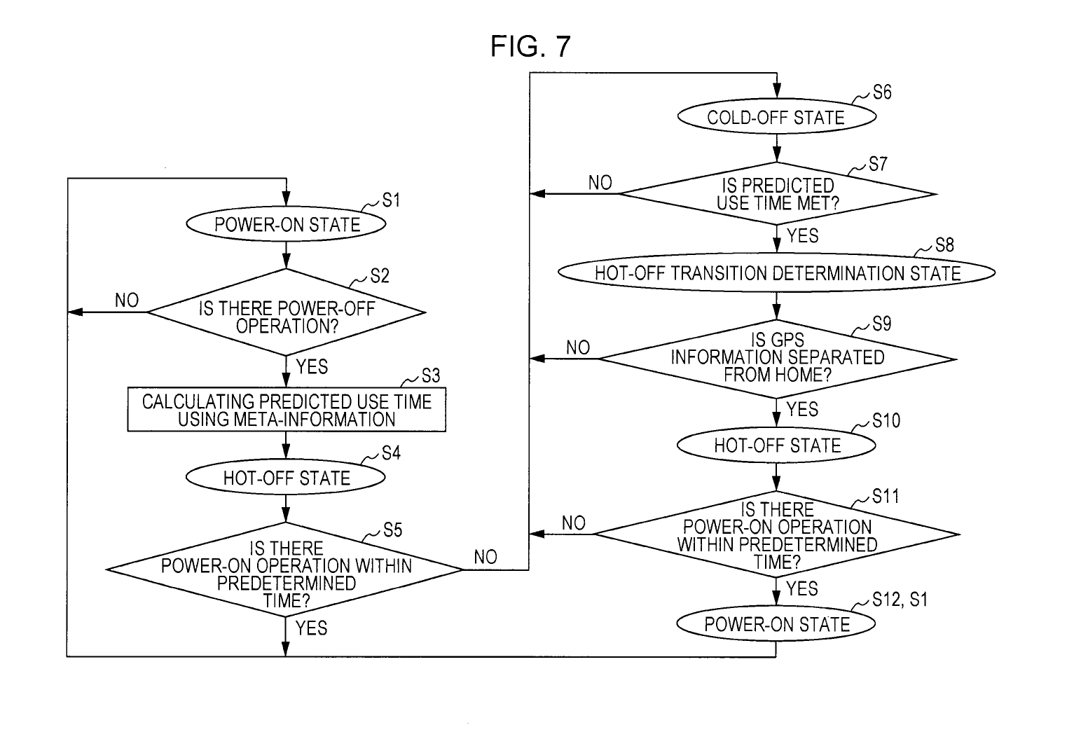

FIG. 7 shows an example of the transition of the state of the image pickup apparatus 1b and an example of a process which is executed during the transition of the state. For example, the image pickup apparatus 1b is put in a power-on state and a user uses the image pickup apparatus 1b (Step S1). In the power-on state, the manipulation input monitoring portion 25b monitors whether or not there is a power-off manipulation to turn off the power switch (Step S2). When there is no power-off manipulation, the power-on state continues. When there is a power-off manipulation, a predicted use time is calculated (Step S3).

For example, the predicted use time is calculated by the control portion 10b with reference to meta-information of the image. The calculated predicted use time is stored as predicted use time data on the sub-storage portion 6b. When there is predicted use time data stored in the past, it is updated to the latest predicted use time data.

When the predicted use time data is stored on the sub-storage portion 6b, the control portion 10b outputs a trigger signal to the power management portion 26b. The power management portion 26b receiving the trigger signal puts the image pickup apparatus 1b in a hot-off state. That is, the power management portion 26b controls power so as to supply the power to the continuously operating portion 4b and the main storage portion 5b from the power source portion 3b. The image pickup apparatus 1b may be in a cold-off state in accordance with the power-off manipulation, but there is a possibility that a power-on manipulation is performed for power-on after the power-off manipulation and images are picked up again. Therefore, it is preferable that the image pickup apparatus 1b is not immediately put in a cold-off state, but is put in a hot-off state. The hot-off state continues for a predetermined time. The predetermined time can be appropriately set, and for example, it is set as 5 to 10 minutes.

It is determined whether or not there is a power-on manipulation within a predetermined time (Step S5). When there is a power-on manipulation, the image pickup apparatus 1b is put in a power-on state (Step S1). At this time, since the image pickup apparatus 1b is in the hot-off state, the image pickup apparatus 1b can be activated at high speed. When there is no power-on manipulation with a predetermined time, the image pickup apparatus 1b is put in a cold-off state (Step S6). For example, when no trigger signal is supplied to the power management portion 26b from the manipulation input monitoring portion 25b with a predetermined time, the power management portion 26b performs control so that only the continuously operating portion 4b is supplied with power. In the cold-off state, only the continuously operating portion 4b is supplied with power and the portions of the continuously operating portion 4b are operated.

In the cold-off state, the hot-off transition determination portion 30 of the continuously operating portion 4b acquires the predicted use time data stored on the sub-storage portion 6b. The hot-off transition determination portion 30 determines whether or not the time information measured by the RTC corresponds to the predicted use time shown by the predicted use time data (Step S7). For example, it is determined whether or not the current time information is “10:00 to 11:00 on Saturday”. When the current time information is “10:00 to 11:00 on Saturday”, the cold-off state continues (Step S6).

When the current time information is “10:00 to 11:00 on Saturday”, the hot-off transition determination portion 30 output a trigger signal to the power management portion 26b. The power management portion 26b receiving the trigger signal controls power so as to supply the power to the GPS information acquiring portion lib, and switches the image pickup state to a hot-off transition determination state (Step S8). Since the GPS information acquiring portion 11b is supplied with power, the GPS information acquiring portion 11b is operated and position information of the image pickup apparatus 1b is acquired. The acquired position information is supplied to the hot-off transition determination portion 30. For example, the position information of the image pickup apparatus 1b is supplied to the hot-off transition determination portion 30 with a predetermined period (for example, 30 seconds).

The hot-off transition determination portion 30 acquires position information of the home of the user stored on the sub-storage portion 6b. The hot-off transition determination portion 30 compares the position information of the home with the position information of the image pickup apparatus 1b, and determines whether or not the position information of the image pickup apparatus 1b is separated from the position information of the home by a predetermined distance or more. For example, it is determined whether or not the position information of the image pickup apparatus 1b is separated from the position information of the home by several tens of meters to about 100 meters. When the position information of the image pickup apparatus 1b is not separated from the position information of the home, the hot-off transition determination portion 30 supplies a trigger signal notifying of the above fact to the power management portion 26b. The power management portion 26b receiving the trigger signal controls the supply of power to put the image pickup apparatus 1b in a cold-off state (Step S6).

When the position information of the image pickup apparatus 1b is separated from the position information of the home by a predetermined distance or more, the hot-off transition determination portion 30 outputs a trigger signal notifying of the above fact to the power management portion 26b. Since the current time corresponds to the predicted use time and the image pickup apparatus 1b is taken out of the home, there is a high possibility that the image pickup apparatus 1b is taken out and used. Therefore, the power management portion 26b supplies power to the main storage portion 5b and stops the supply of power to the GPS information acquiring portion 11b, thereby putting the image pickup apparatus 1b in a hot-off state (Step S10).

Even when the image pickup apparatus 1b transits to the hot-off state, the image pickup apparatus 1b has no change in the appearance. Therefore, a user doesn't recognize the transition to the hot-off state. When the state transits to the hot-off state or the hot-off transition determination state, it may be displayed on the LED or the like provided in the image pickup apparatus 1b to change the appearance of the image pickup apparatus 1b. However, since there is also concern that a user may be bewildered by the content of the display, it is preferable that the appearance of the image pickup apparatus 1b is not changed.

After the image pickup apparatus 1b transits to the hot-off state, it is determined whether or not there is a power-on manipulation within a predetermined time (Step S11). The predetermined time can be appropriately set. For example, it is set to about 30 minutes. When there is no power-on manipulation within a predetermined time, the image pickup apparatus 1b is put in a cold-off state (Step S6). For example, when no trigger signal corresponding to the power-on manipulation is supplied to the power management portion 26b from the manipulation input monitoring portion 25b with a predetermined time, the power management portion 26b performs control to supply power only to the continuously operating portion 4b.

When there is a power-on manipulation within a predetermined time, the image pickup apparatus 1b is put in a power-on state. For example, a trigger signal notifying of the power-on manipulation is supplied to the power management portion 26b from the manipulation input monitoring portion 25b. The power management portion 26b performs control to supply power to the portions of the image pickup apparatus 1b such as the main processing portion 2b and the GPS information acquiring portion 11b. Since the image pickup apparatus 1b is in a hot-off state, the image pickup apparatus 1b can be activated at high speed and can rapidly transit to a power-on state. Therefore, after the power-on manipulation, a user can immediately perform picking-up of images and the like using the image pickup apparatus 1b.

As described above, since it is detected whether or not the current time corresponds to a time period during which the image pickup apparatus is frequently used, and also detected that the image pickup apparatus is carried, it is possible to appropriately determine when the image pickup apparatus is likely to be used. It is possible to minimize a time during which the image pickup apparatus is put in a hot-off state and to prevent excessive power consumption of the power source portion. Furthermore, when the image pickup apparatus is likely to be used, the image pickup apparatus can be activated at high speed.

### 2. Second Embodiment

Example of Configuration of Image Pickup Apparatus according to Second Embodiment

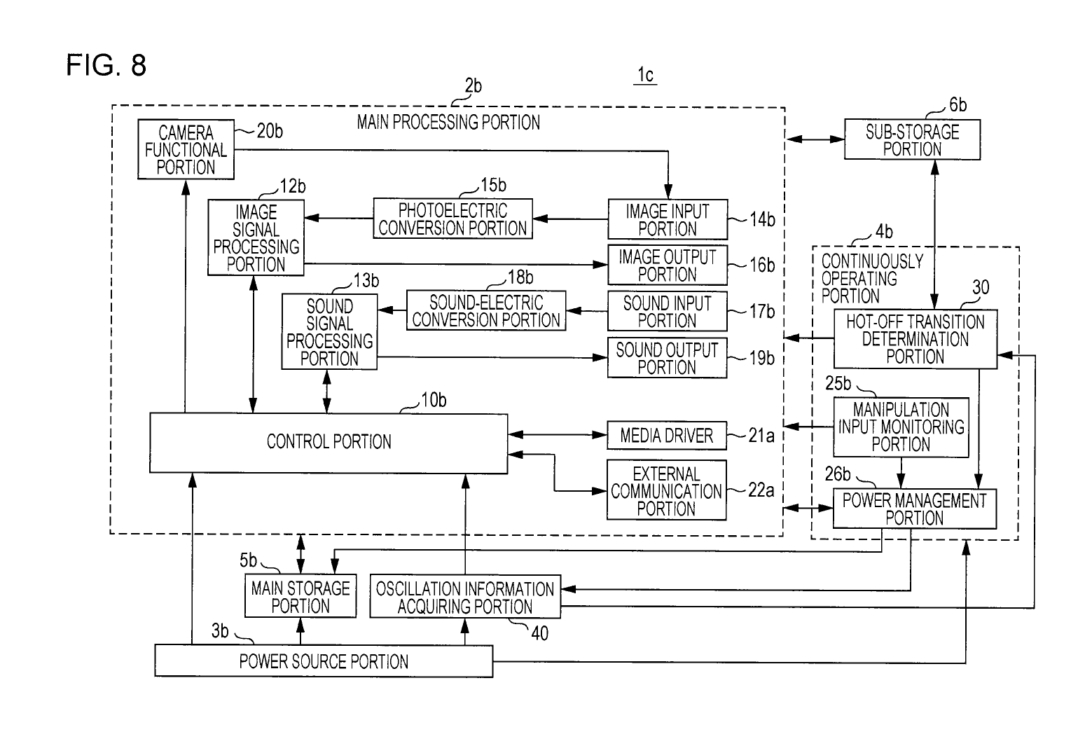

Next, a second embodiment will be described. FIG. 8 shows an example of the configuration of an image pickup apparatus according to the second embodiment. In an image pickup apparatus 1c shown in FIG. 8, the same configurations as those of the above-described image pickup apparatus 1b will be denoted by the same reference symbols, and overlapping descriptions thereof will be omitted. The portions of the image pickup apparatus 1c execute the same processes as those of the corresponding configurations of the image pickup apparatus 1b unless otherwise mentioned.

The image pickup apparatus 1c has an oscillation information acquiring portion 40 in place of the GPS information acquiring portion 11b. As the oscillation information acquiring portion 40, for example, an oscillation sensor can be applied. The oscillation information acquiring portion 40 detects oscillation information of the image pickup apparatus 1c, and the detected oscillation information is supplied to the hot-off transition determination portion 30. The supply of power to the oscillation information acquiring portion 40 is performed in the substantially same manner as in the case of the supply of power to the GPS information acquiring portion lib. That is, when the hot-off transition determination portion 30 determines that the current time corresponds to a predicted use time, the image pickup apparatus 1c transits to a hot-off state and the oscillation information acquiring portion 40 is supplied with power.

The oscillation information acquiring portion 40 acquires the oscillation information of the image pickup apparatus 1c when supplied with power. The acquired oscillation information is supplied to the hot-off transition determination portion 30. The hot-off transition determination portion 30 accumulates, for example, the oscillation quantity of the image pickup apparatus 1c, and outputs a trigger signal to the power management portion 26b when the accumulated oscillation quantity is a predetermined value or more. The power management portion 26b receiving the trigger signal stops the supply of power to the oscillation information acquiring portion 40, and starts the supply of power to the main storage portion 5b. Accordingly, the activation program is loaded to the main storage portion 5b and the image pickup apparatus 1c is put in a hot-off state.

Transition of State of Image Pickup Apparatus according to Second Embodiment

Since the transition of the state of the image pickup apparatus 1c is substantially the same as the transition of the state of the image pickup apparatus 1b, it will be schematically described. In the hot-off transition determination state of Step S8 of FIG. 7, the continuously operating portion 4b and the oscillation information acquiring portion 40 are supplied with power. In addition, the oscillation information acquiring portion 40 acquires oscillation information.

In the determination process of Step S9, for example, it is determined whether or not the accumulated oscillation quantity is greater than a threshold. When the accumulated oscillation quantity is less than the threshold, the image pickup apparatus 1c is put in a cold-off state (Step S6). When the accumulated oscillation quantity is greater than the threshold, the image pickup apparatus 1c is put in a hot-off state (Step S10). Since other processes are the same as in the above-described first embodiment, overlapping descriptions thereof will be omitted.

In the second embodiment, whether or not the image pickup apparatus is carried is determined using the oscillation information. Regarding the oscillation information acquiring portion, it can be configured at relatively lower cost than the GPS information acquiring portion, and the power consumption in the hot-off transition determination state can be reduced. Furthermore, it is useful for an environment in which GPS information is not acquired. As the oscillation information, the number of times when a displacement equal to or greater than a predetermined value is measured may be used.

Modification Examples of Image Pickup Apparatus According to Second Embodiment

For example, a predicted use time period during which there is a high possibility of using the image pickup apparatus 1c at home may be set. For example, on particular days such as Christmas or birthday (hereinafter, appropriately referred to as the particular day), there is a higher possibility of using the image pickup apparatus at home than go out. Such particular days and predetermined time periods on the particular days are set as predicted use time periods. In addition, in the case of a particular day, a threshold for the oscillation information is changed to be reduced to easily detect the oscillation of the image pickup apparatus 1c. When the oscillation is detected, it is relatively rapidly determined that images are picked up indoors. Accordingly, when the current time corresponds to a predicted use time period and the oscillation information acquiring portion 40 detects the oscillation, the image pickup apparatus 1c transits to a hot-off state from a hot-off transition determination state.

When the current time corresponds to a time period during which there is a high possibility of using the image pickup apparatus 1c at home, the image pickup apparatus 1c transits to a hot-off state when a slight oscillation is detected. Accordingly, even when the image pickup apparatus 1c is used at home, the image pickup apparatus 1c can transit to the hot-off state at an appropriate timing. The same process as the above-described process is executed on days other than the particular days.

### 3. Modification Examples

Although the plurality of embodiments of the present disclosure have been described, the present disclosure is not limited to the above-described embodiments, and various modifications can be made.

In the above-described embodiments, the description has been provided in which the hot-off state is a state in which the main storage portion 5b is supplied with power and the activation program is loaded to the main storage portion 5b. However, other states may be the hot-off state as long as the image pickup apparatus can be activated at high speed.

The GPS information acquiring portion and the oscillation information acquiring portion may be incorporated into the continuously operating portion. The GPS information acquiring portion may be constituted of a gyro sensor. The information about the distance and the time exemplified in the above-described embodiments may be set by a user.

The present disclosure can be realized by methods, programs, recording mediums on which programs are recorded, and the like other than apparatuses. The configurations and the processes in the embodiments and the modification examples can be appropriately changed and combined with each other within a scope not causing technical incompatibility. A telephone function may be added to the image pickup apparatus. The present disclosure may be applied to a so-called cloud system in which the exemplified processes are distributed to a plurality of devices and processed. For example, an image picked up by the image pickup apparatus is transmitted to a server and a predicted use time is calculated by the server. The calculated predicted use time may be transmitted to the image pickup apparatus from the server.

The present disclosure can employ the following configurations.

(1) An image pickup apparatus including an image pickup control portion which includes an image pickup portion and a processing portion performing a process of image picking-up; a position information acquiring portion which acquires position information; a time information acquiring portion which acquires time information; and a power management portion which controls supply of power to the portions, in which the power management portion and the time information acquiring portion are continuously supplied with power, when the time information corresponds to a predicted use time, the position information acquiring portion is supplied with power, and when the position information is separated from position information of a predetermined place by a predetermined distance or more, a memory for program execution is supplied with power.

(2) The image pickup apparatus according to (1) in which when there is a power-on manipulation, the image pickup control portion is supplied with power.

(3) The image pickup apparatus according to (2) in which the predicted use time is calculated with reference to time information accompanying the content picked up by the image pickup portion.

(4) The image pickup apparatus according to (3) in which when there is a power-off manipulation, the predicted use time is calculated.

(5) The image pickup apparatus according to any one of (1) to (4) in which the position information of the predetermined place is position information of a user's base.

(6) An image pickup apparatus which can transit to a state in which at least a continuously operating portion and a memory for program execution are supplied with power, and transits to the state when time information corresponds to a predicted use time and position information is separated from position information of a predetermined place by a predetermined distance or more.

(7) An image pickup apparatus including an image pickup control portion which includes an image pickup portion and a processing portion performing a process of image picking-up; an oscillation information acquiring portion which acquires oscillation information; a time information acquiring portion which acquires time information; and a power management portion which controls supply of power to the portions, in which the power management portion and the time information acquiring portion are continuously supplied with power, when the time information corresponds to a predicted use time, the oscillation information acquiring portion is supplied with power, and when the oscillation information is a predetermined value or more, a memory for program execution is supplied with power.

(8) An image pickup apparatus which can transit to a state in which at least a continuously operating portion and a memory for program execution are supplied with power, and transits to the state when time information corresponds to a predicted use time and oscillation information is a predetermined value or more.

(9) A power supply method in which a power management portion and a time information acquiring portion are continuously supplied with power, when time information corresponds to a predicted use time, a position information acquiring portion is supplied with power, and when position information is separated from position information of a predetermined place by a predetermined distance or more, a memory for program execution is supplied with power.

(10) A power supply method in which a power management portion and a time information acquiring portion are continuously supplied with power, when time information corresponds to a predicted use time, an oscillation information acquiring portion is supplied with power, and when oscillation information is a predetermined value or more, a memory for program execution is supplied with power.

The present disclosure contains subject matter related to that disclosed in Japanese Priority Patent Application JP 2011-290377 filed in the Japan Patent Office on Dec. 29, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image pickup apparatus comprising:
an image pickup control portion which includes an image pickup portion and a processing portion performing a process of image picking-up;
a position information acquiring portion which acquires position information;
a time information acquiring portion which acquires time information; and
a power management portion which controls supply of power to the portions,
wherein the power management portion and the time information acquiring portion are continuously supplied with power,
when the time information corresponds to a predicted use time, the position information acquiring portion is supplied with power, and
when the position information is separated from position information of a predetermined place by a predetermined distance or more, a memory for program execution is supplied with power.

2. The image pickup apparatus according to claim 1,
wherein when there is a power-on manipulation, the image pickup control portion is supplied with power.

3. The image pickup apparatus according to claim 2,
wherein the predicted use time is calculated with reference to time information accompanying the content picked up by the image pickup portion.

4. The image pickup apparatus according to claim 3,
wherein when there is a power-off manipulation, the predicted use time is calculated.

5. The image pickup apparatus according to claim 1,
wherein the position information of the predetermined place is position information of a user's base.

6. An image pickup apparatus which can transit to a state in which at least a continuously operating portion and a memory for program execution are supplied with power, and transits to the state when time information corresponds to a predicted use time and position information is separated from position information of a predetermined place by a predetermined distance or more.

7. An image pickup apparatus comprising:
an image pickup control portion which includes an image pickup portion and a processing portion performing a process of image picking-up;
an oscillation information acquiring portion which acquires oscillation information;
a time information acquiring portion which acquires time information; and
a power management portion which controls supply of power to the portions,
wherein the power management portion and the time information acquiring portion are continuously supplied with power,
when the time information corresponds to a predicted use time, the oscillation information acquiring portion is supplied with power, and
when the oscillation information is a predetermined value or more, a memory for program execution is supplied with power.

8. An image pickup apparatus which can transit to a state in which at least a continuously operating portion and a memory for program execution are supplied with power, and transits to the state when time information corresponds to a predicted use time and oscillation information is a predetermined value or more.

9. A power supply method,
wherein a power management portion and a time information acquiring portion are continuously supplied with power,
when time information corresponds to a predicted use time, a position information acquiring portion is supplied with power, and
when position information is separated from position information of a predetermined place by a predetermined distance or more, a memory for program execution is supplied with power.

10. A power supply method,
wherein a power management portion and a time information acquiring portion are continuously supplied with power,
when time information corresponds to a predicted use time, an oscillation information acquiring portion is supplied with power, and
when oscillation information is a predetermined value or more, a memory for program execution is supplied with power.
